(19) United States
(12) Patent Application Publication
(10) Pub. No.: US 2024/0213572 A1
(43) Pub. Date: Jun. 27, 2024

(54) FLOW RATE EQUALIZERS FOR COOLING ELECTROCHEMICAL CELL SYSTEMS

(71) Applicant: 24M Technologies, Inc., Cambridge, MA (US)

(72) Inventor: Khosrow Nematollahi, Carmel, IN (US)

(21) Appl. No.: 18/392,049

(22) Filed: Dec. 21, 2023

Related U.S. Application Data
(60) Provisional application No. 63/434,568, filed on Dec. 22, 2022.

(51) Int. Cl. H01M 10/6551; H01M 10/613; H01M 10/6563; H01M 10/6567

(52) U.S. Cl. CPC H01M 10/6551; H01M 10/613; H01M 10/6563; H01M 10/6567

(57) ABSTRACT

Embodiments described herein relate to a plenum including an inlet configured to receive fluid from a coolant system, a plurality of outlets configured to fluidly couple to a plurality of heat exchangers, and a tapered portion corresponding to the plurality of outlets, the tapered configured to maintain the fluid at a desired speed. In some embodiments, the tapered portion can include a first portion defining a first taper rate and a second portion defining a second taper rate. In some embodiments, the second taper rate can be lower than the first taper rate. In some embodiments, the inlet can include two inlet ports.

### CROSS-REFERENCE TO RELATED APPLICATIONS

This application claims priority to and the benefit of U.S. Provisional Patent Application No. 63/434,568, filed Dec. 22, 2022 and titled, “Flow Rate Equalizers for Cooling Electrochemical Cell Systems,” the disclosure of which is hereby incorporated by reference in its entirety.

### TECHNICAL FIELD

Embodiments described herein relate to cooling devices for electrochemical cell systems.

### BACKGROUND

Electrochemical cell systems release heat during operation and may require cooling to keep at a desired operating temperature. Operating electrochemical cell systems at a desired operating temperature may prevent the electrochemical cell system from overheating and/or may allow the electrochemical cell system to operate at a desired efficiency. Current cooling methods, however, do not distribute coolant across the electrochemical cell system evenly and result in electrochemical cell systems with uneven temperatures across the cells. This may result in inefficiencies and uneven wear on the cells. Thus, a device that cools electrochemical cell systems evenly is desirable.

### SUMMARY

In some aspects, embodiments described herein relate to a plenum including at least one inlet configured to receive fluid from a coolant system, a plurality of outlets configured to fluidly couple to a plurality of heat exchangers, and a tapered portion corresponding to the plurality of outlets, the tapered configured to maintain the fluid at a desired speed. In some embodiments, the tapered portion can include a first portion defining a first taper rate and a second portion defining a second taper rate. In some embodiments, the second taper rate can be lower than the first taper rate. In some embodiments, the at least one inlet can include two inlet ports.

### BRIEF DESCRIPTION OF THE DRAWINGS

FIG. 1 is a block diagram of a battery system, according to an embodiment.

FIGS. 2A-2D are illustrations of a plenum, according to an embodiment.

FIGS. 3A-3B are illustrations of an alternate heat exchanger, according to an embodiment.

FIGS. 4A-4B are illustrations of a plenum, according to an embodiment.

FIG. 5 is an illustration of fluid flow through a plenum and heat exchangers, according to an embodiment.

FIG. 6 is an illustration of a side view of a double plenum configuration, according to an embodiment.

FIG. 7 is an illustration of a base for mounting plenums, according to an embodiment.

FIG. 8 is an illustration of a battery system, according to an embodiment.

FIG. 9 is a flow diagram of a method of cooling an electrochemical cell system, according to an embodiment.

### DETAILED DESCRIPTION

Embodiments described herein relate to cooling devices for electrochemical cell systems. Electrochemical cell systems are often designed to operate at or below a desired temperature, as higher temperatures may damage electrochemical cell efficiency and electrochemical structure of the system. As electrochemical cell systems release heat during operation, cooling the systems allows for the systems to operate at or below the desired temperature.

To cool the systems, a heat transfer fluid (e.g., coolant, heating fluid) can be transferred through heat exchangers thermally coupled to the cells of the system. In some embodiments, a fluid (e.g., gas coolant, liquid coolant, etc.) may be pumped through heat exchangers thermally coupled to the cells of the system. Pumping fluid through the heat exchangers evenly ensures that the cells are not operating at different temperatures. Temperature gradients in electrochemical cells and electrochemical cell systems can have detrimental effects on cell capacity and capacity retention. Some embodiments described herein include a flow rate equalizer that provides equal fluid flow to each heat exchanger in an electrochemical cell system and reduce temperature gradients. As described herein, fluid is transferred through the electrochemical cell system to draw heat away from the electrochemical cells. In some embodiments, a heating fluid can be transferred through the electrochemical cell system to heat the electrochemical cells.

In some embodiments, a plenum (e.g., flow rate equalizer) may include at least one inlet and a tapered portion extending away from the inlet. The tapered portion includes outlets configured to accept heat exchangers. The converging shape of the tapered portion accelerates the flow of fluid within the tapered portion such that the speed of the fluid exiting each outlet into a corresponding heat exchanger or Triple Chamber Cold Plate is roughly equal, thus allowing the heat exchangers to evenly cool the electrochemical cells.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the term “electrochemical cell” refers to a device that converts chemical energy to electrical energy. Electrochemical cells can be housed within pouches that may allow for heat to dissipate during operation. Connecting electrochemical cells in parallel, series, or any combination thereof forms a battery.

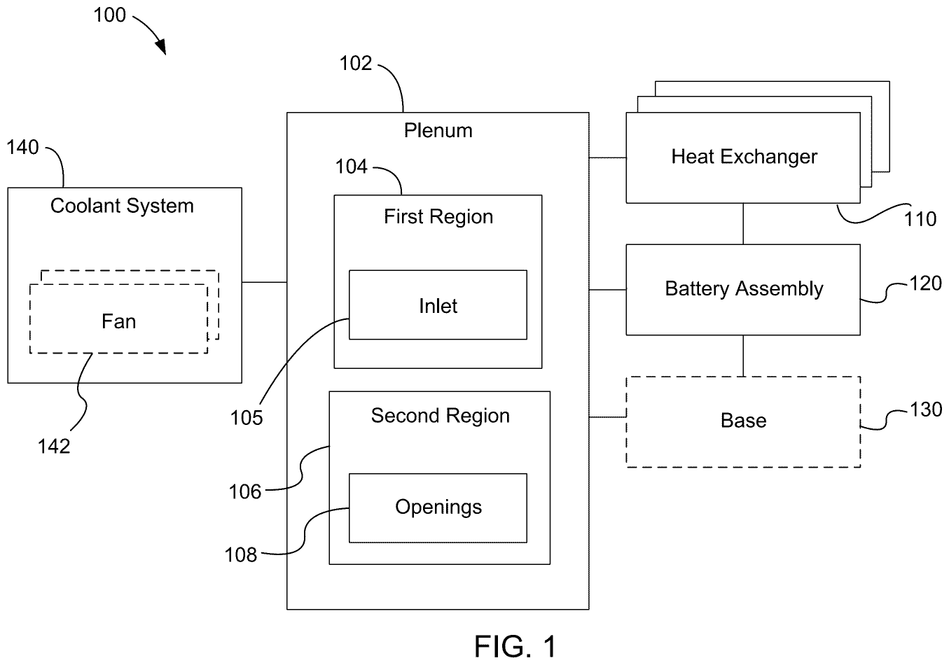

FIG. 1 is a block diagram of a battery system 100, according to an embodiment. The battery system 100 includes a plenum 102 having a first region 104 with an inlet 105, and a second region 106 with outlets 108. The plenum 102 is coupled to heat exchangers 110 and a battery assembly 120 which is further coupled to the heat exchangers 110. In some embodiments, the battery system 100 includes a base 130 coupled to the plenum 102 and the battery assembly 120. The plenum 102 is further coupled to a coolant system 140. In some embodiments, the coolant system 140 includes one or more fans 142.

The plenum 102 is a flow rate equalizer configured to receive fluid from the coolant system 140 and evenly distribute the fluid to the heat exchangers 110. The first region 104 of the plenum 102 fluidly couples to the coolant system 140 and receives fluid via at least one inlet 105. In some embodiments, the first region 104 tapers away from the at least one inlet 105 to accelerate the fluid. In some embodiments, the first region 104 may include features that allow for the coolant system 140 to couple to the first region 104. The first region 104 is contiguous to and fluidly couples to the second region 106 which is configured to receive the fluid from the first region 104. The second region 106 includes outlets 108 that serve as outlets for the fluid. The second region 106 tapers away from the first region 104 to accelerate the fluid such that the speed of the fluid exiting each outlet 108 is roughly equal. In some embodiments, the battery system 100 may include multiple plenums 102.

The second region 106 couples to the heat exchangers 110 such that the fluid may flow from the plenum 102 to the heat exchangers 110 through the outlets 108. The heat exchangers 110 thermally couple to the battery assembly 120 to dissipate the heat generated by the battery assembly 120. The battery assembly 120 may include any number of electrochemical cells. For example, the battery assembly 120 may include at least one electrochemical cell, at least two electrochemical cells, at least three electrochemical cells, at least four electrochemical cells, at least five electrochemical cells, at least six electrochemical cells, at least seven electrochemical cells, at least eight electrochemical cells, at least nine electrochemical cells, at least 10 electrochemical cells, at least 15 electrochemical cells, at least 20 electrochemical cells, at least 30 electrochemical cells, at least 40 electrochemical cells, at least 50 electrochemical cells, at least 75 electrochemical cells, or at least 100 electrochemical cells. In some embodiments, the battery assembly 120 includes no more than 100 electrochemical cells, no more than 75 electrochemical cells, no more than about 50 electrochemical cells, no more than about 40 electrochemical cells, no more than about 30 electrochemical cells, no more than about 20 electrochemical cells, no more than about 15 electrochemical cells, no more than about 10 electrochemical cells, no more than about nine electrochemical cells, no more than about eight electrochemical cells, no more than about seven electrochemical cells, no more than about six electrochemical cells, no more than about five electrochemical cells, no more than four electrochemical cells, no more than about three electrochemical cells, no more than about two electrochemical cells, or no more than about one electrochemical cell. Combinations of the above referenced number of electrochemical cells are also possible (e.g., no more than 20 electrochemical cells and at least about 10 electrochemical cells, at least one electrochemical cell and no more than 100 electrochemical cells, etc.), inclusive of all ranges and values therebetween. In some embodiments, the battery assembly 120 includes one electrochemical cell, two electrochemical cells, three electrochemical cells, four electrochemical cells, five electrochemical cells, six electrochemical cells, seven electrochemical cells, eight electrochemical cells, nine electrochemical cells, 10 electrochemical cells, 15 electrochemical cells, 20 electrochemical cells, 30 electrochemical cells, 40 electrochemical cells, 50 electrochemical cells, 75 electrochemical cells, or 100 electrochemical cells. In some embodiments, the heat exchangers 110 can be the same or substantially similar to the heat exchangers described in U.S. Provisional Patent Application No. 63/433,234 (“the '234 Application), filed Dec. 16, 2022, and titled, “Electrochemical Cell Systems with Multi-Chamber Cooling Devices, and Methods of Producing the Same,” the disclosure of which is hereby incorporated by reference in its entirety.

The number of heat exchangers 110, and the number of corresponding outlets 108, may correspond to the number of electrochemical cells in the battery assembly 120. For every heat exchanger 110, there may be at least one electrochemical cell, at least two electrochemical cells, at least three electrochemical cells, at least four electrochemical cells, at least five electrochemical cells, at least six electrochemical cells, at least seven electrochemical cells, at least eight electrochemical cells, at least nine electrochemical cells, or at least 10 electrochemical cells. In some embodiments, for every heat exchanger 110, there are no more than 10 electrochemical cells, no more than nine electrochemical cells, no more than eight electrochemical cells, no more than seven electrochemical cells, no more than six electrochemical cells, no more than five electrochemical cells, no more than four electrochemical cells, no more than three electrochemical cells, no more than two electrochemical cells, or no more than one electrochemical cell. Combinations of the above referenced ratio of heat exchangers 110 to number of electrochemical cells may be possible (e.g., at least one electrochemical cell and no more than 10 electrochemical cells, at least one electrochemical cell and no more than 5 electrochemical cells, etc.), inclusive of all values and ranges therebetween. In some embodiments, for every heat exchanger 110 there is one electrochemical cell, two electrochemical cells, three electrochemical cells, four electrochemical cells, five electrochemical cells, six electrochemical cells, seven electrochemical cells, eight electrochemical cells, nine electrochemical cells, or 10 electrochemical cells.

In some embodiments, the plenum 102 may be coupled to the battery assembly 120 via a base 130. The base 130 may additionally couple to a surface to secure the battery system 100 to the surface. The base 130 may be configured to accept more than one plenum 102.

The coolant system 140 drives the flow of fluid into the plenum 102. In some embodiments, the coolant system 140 includes a pumping mechanism (e.g., the fans 142, a pump, etc.). In some embodiments, the coolant system 140 includes a primary pumping mechanism and a secondary redundant pumping mechanism. In some embodiments, the coolant system 140 may include a pumping system including multiple pumping mechanisms to bring the fluid to a desired speed. In some embodiments, the coolant system 140 is mounted directly to the plenum 102. In some embodiments, the coolant system 140 includes conduits that direct fluid to the plenum 102. In some embodiments, the coolant system 140 includes a coolant reservoir. In some embodiments, such as when the fluid is air and/or when the battery system 100 is submerged in fluid, the coolant system 140 may only include pumping mechanisms coupled to the plenum 102.

In some embodiments, upon entering the plenum 102 via the inlet 105, the heat transfer fluid can have a temperature of can have a temperature of at least about −50° C., at least about −40° C., at least about −30° C., at least about −20° C., at least about −10° C., at least about 0° C., at least about 10° C., at least about 20° C., at least about 30° C., at least about 40° C., at least about 50° C., at least about 60° C., at least about 70° C., at least about 80° C., at least about 90° C., at least about 100° C., at least about 110° C., at least about 120° C., at least about 130° ° C., at least about 140° C., at least about 150° C., at least about 160° C., at least about 170° C., at least about 180° C., or at least about 190° C. In some embodiments, upon entering the plenum 102 via the inlet 105, the heat transfer fluid can have a temperature of no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., no more than about 90° C., no more than about 80° C., no more than about 70° C., no more than about 60° C., no more than about 50° C., no more than about 40° C., no more than about 30° C., no more than about 20° C., no more than about 10° C., no more than about 0° C., no more than about −10° C., no more than about −20° C., no more than about −30° C., or no more than about −40° C. Combinations of the above-referenced temperatures are also possible (e.g., at least about −50° C. and no more than about 200° C. or at least about 20° C. and no more than about 60° C.), inclusive of all values and ranges therebetween. In some embodiments, upon entering the plenum 102 via the inlet 105, the heat transfer fluid can have a temperature of about −50° C., about −40° C., about −30° C., about −20° C., about −10° C., about 0° C., about 10° C., about 20° ° C., about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° ° C., or about 200° C.

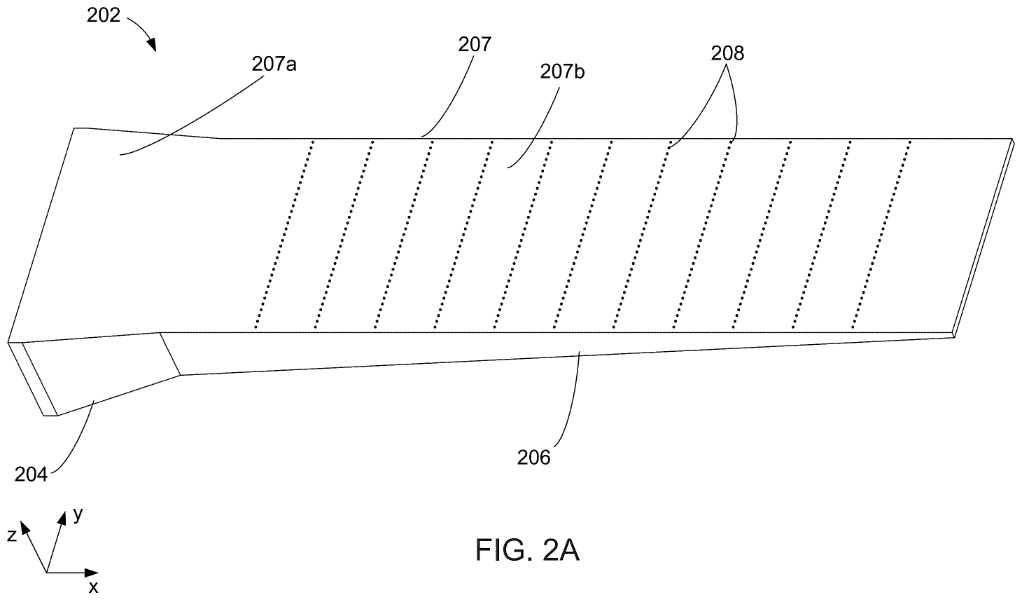

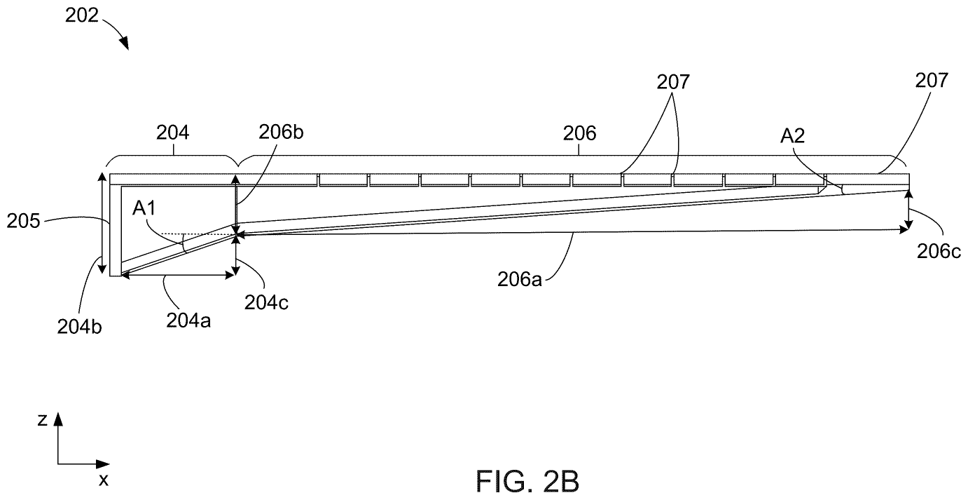

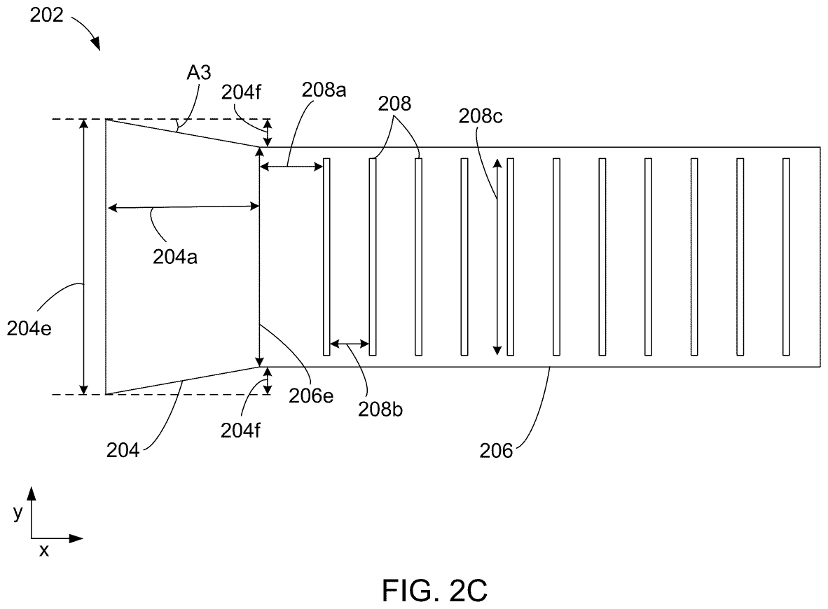

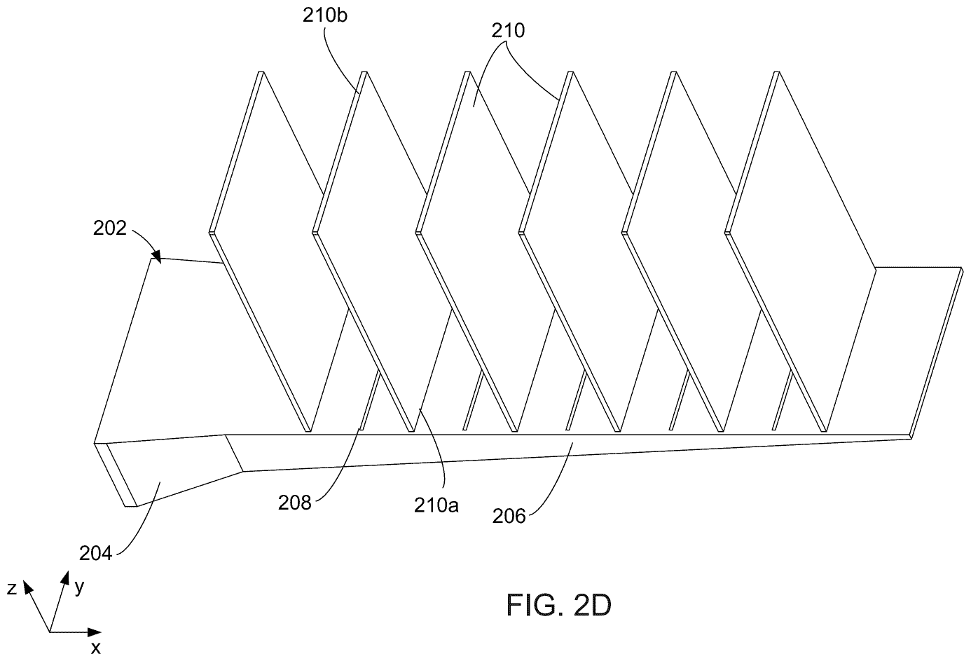

FIGS. 2A-2D are illustrations of a plenum 202, according to an embodiment. Axes (x, y, and z-axes) are shown in FIGS. 2A-2D for directional clarity. FIG. 2A is an illustration of a perspective view of the plenum 202, according to an embodiment. In some embodiments, the plenum 202 can be structurally and/or functionally similar to the plenum 102, as described above with reference to FIG. 1. The plenum 202 includes a first portion 204 (e.g., structurally and/or functionally similar to the first portion 104 of FIG. 1), a second portion 206 (e.g., structurally and/or functionally similar to the second portion 106 of FIG. 1), and a plurality of outlets 208 (e.g., structurally and/or functionally similar to the outlets 108 of FIG. 1) in the second portion 206.

As seen in FIG. 2A, the first portion 204 and the second portion 206 are contiguous portions of the plenum 202 and together form a plane surface 207. The plane surface 207 is flat along the length of the plenum 202 with a first portion surface 207a and a second portion surface 207b. In some embodiments, the plane surface 207 may only be located along the second portion 206 (e.g., the plenum 202 only includes the second portion surface 207b). The outlets 208 are located on the second portion surface 207b. The second portion surface 207b may have any number of outlets 208. For example, the number of outlets 208 on the second portion surface 207b can be at least one, at least two, at least three, at least four, at least five, at least six, at least seven, at least eight, at least nine, at least 10, at least 15, at least 20, at least 25, at least 30, at least 40, or at least 50. In some embodiments, the number of outlets 208 on the second portion surface 207b is no more than 50, no more than 40, no more than 30, no more than 25, no more than 20, no more than 15, no more than 10, no more than nine, no more than eight, no more than seven, no more than six, no more than five, no more than four, no more than three, no more than two, or no more than one. Combinations of the above-referenced numbers of outlets 208 are also possible (e.g., at least five outlets 208 and no more than 10 outlets 208 or at least 20 outlets 208 and no more than 40 outlets 208), inclusive of all values and ranges therebetween. In some embodiments, the number of outlets 208 on the second portion surface is one, two, three, four, five, six, seven, eight, nine, 10, 15, 20, 25, 30, 40, or 50. In the embodiment depicted in FIG. 2A, the plenum 202 includes 11 outlets 208. In some embodiments, the outlets 208 may be plugged when the plenum 202 is not in use.

The first portion 204 tapers from one end to the second portion 206, such that the shape of the first portion 204 and the shape of the second portion 206 is the same at the coupling point between the first portion 204 and the second portion 206. In some embodiments, the width of the first portion 204 tapers. In some embodiments, the height of the first portion 204 tapers. In some embodiments, both the first portion and the second portion of the first portion 204 taper. The taper of the first portion 204 may be configured to accelerate fluid from an intake speed to a desired speed. In some embodiments, the intake speed and the desired speed are approximately equal. In some embodiments, the desired speed is greater than the intake speed

In some embodiments, the intake speed is at least about 0.1 m/s, at least about 0.2 m/s, at least about 0.3 m/s, at least about 0.4 m/s, at least about 0.5 m/s, at least about 0.6 m/s, at least about 0.7 m/s, at least about 0.8 m/s, at least about 0.9 m/s, at least about 1 m/s, at least about 1.5 m/s, at least about 2 m/s, at least about 2.5 m/s, at least about 3 m/s, at least about 4 m/s, at least about 4 m/s, at least about 5 m/s, at least about 6 m/s, at least about 7 m/s, at least about 8 m/s, at least about 9 m/s, at least about 10 m/s, at least about 15 m/s, at least about 20 m/s, or at least about 30 m/s. In some embodiments, the intake speed is no more than about 30 m/s, no more than about 20 m/s, no more than about 15 m/s, no more than about 10 m/s, no more than about 9 m/s, no more than about 8 m/s, no more than about 7 m/s, no more than about 6 m/s, no more than about 5 m/s, no more than about 4 m/s, no more than about 3 m/s, no more than about 2.5 m/s, no more than about 2 m/s, no more than about 1.5 m/s, no more than about 1 m/s, no more than about 0.9 m/s, no more than about 0.8 m/s, no more than about 0.7 m/s, no more than about 0.6 m/s, no more than about 0.5 m/s, no more than about 0.4 m/s, no more than about 0.3 m/s, no more than about 0.2, or no more than about 0.1 m/s. Combinations of the above-referenced intake speeds are also possible (e.g., at least about 0.1 m/s and no more than about 30 m/s or at least about 3 m/s and no more than 10 m/s), inclusive of all values and ranges therebetween. In some embodiments, the intake speed is about 0.1 m/s, about 0.2 m/s, about 0.3 m/s, about 0.4 m/s, about 0.5 m/s, about 0.6 m/s, about 0.7 m/s, about 0.8 m/s, about 0.9 m/s, about 1 m/s, about 1.5 m/s, about 2.0 m/s, about 2.5 m/s, about 3 m/s, about 4 m/s, about 5 m/s, about 6 m/s, about 7 m/s, about 8 m/s, about 9 m/s, about 10 m/s, about 15 m/s, about 20 m/s, or about 30 m/s.

In some embodiments, the desired speed is at least about 0.1 m/s, at least about 0.2 m/s, at least about 0.3 m/s, at least about 0.4 m/s, at least about 0.5 m/s, at least about 0.6 m/s, at least about 0.7 m/s, at least about 0.8 m/s, at least about 0.9 m/s, at least about 1 m/s, at least about 1.5 m/s, at least about 2 m/s, at least about 2.5 m/s, at least about 3 m/s, at least about 4 m/s, at least about 4 m/s, at least about 5 m/s, at least about 6 m/s, at least about 7 m/s, at least about 8 m/s, at least about 9 m/s, at least about 10 m/s, at least about 15 m/s, at least about 20 m/s, at least about 30 m/s, at least about 40 m/s, or at least about 50 m/s. In some embodiments, the desired speed is no more than about 50 m/s, no more than about 40 m/s, no more than about 30 m/s, no more than about 20 m/s, no more than about 15 m/s, no more than about 10 m/s, no more than about 9 m/s, no more than about 8 m/s, no more than about 7 m/s, no more than about 6 m/s, no more than about 5 m/s, no more than about 4 m/s, no more than about 3 m/s, no more than about 2.5 m/s, no more than about 2 m/s, no more than about 1.5 m/s, no more than about 1 m/s, no more than about 0.9 m/s, no more than about 0.8 m/s, no more than about 0.7 m/s, no more than about 0.6 m/s, no more than about 0.5 m/s, no more than about 0.4 m/s, no more than about 0.3 m/s, no more than about 0.2, or no more than about 0.1 m/s. Combinations of the above-referenced desired speeds are also possible (e.g., at least about 0.1 m/s and no more than about 50 m/s or at least about 3 m/s and no more than 10 m/s), inclusive of all values and ranges therebetween. In some embodiments, the desired speed is about 0.1 m/s, about 0.2 m/s, about 0.3 m/s, about 0.4 m/s, about 0.5 m/s, about 0.6 m/s, about 0.7 m/s, about 0.8 m/s, about 0.9 m/s, about 1 m/s, about 1.5 m/s, about 2.0 m/s, about 2.5 m/s, about 3 m/s, about 4 m/s, about 5 m/s, about 6 m/s, about 7 m/s, about 8 m/s, about 9 m/s, about 10 m/s, about 15 m/s, about 20 m/s, about 30 m/s, about 40 m/s, or about 50 m/s.

Combinations of the above-referenced intake speed and desired speed are possible, inclusive of all ranges and values therebetween. For example, the intake speed may be at least about 2 m/s and the desired speed may be at least about 5 m/s or the intake speed may be at least about 5 m/s and no more than 7 m/s and the desired speed may be at least about 7 m/s and no more than 10 m/s. In some embodiments, the ranges and values of the desired speed may be conditional on the desired speed being greater than the intake speed.

In some embodiments, the desired speed may be directly related to the intake speed. In some embodiments, the ratio between the desired speed and the intake speed may be at least about 1.1, at least about 1.2, at least about 1.3, at least about 1.4, at least about 1.5, at least about 1.6, at least about 1.7, at least about 1.8, at least about 1.9, at least about 2.0, at least about 2.5, at least about 3.0, at least about 4.0, or at least about 5.0. In some embodiments, the ratio between the desired speed and the intake speed may be no more than about 5.0, no more than about 4.0, no more than about 3.0, no more than about 2.5, no more than about 2.0, no more than about 1.9, no more than about 1.8, no more than about 1.7, no more than about 1.6, no more than about 1.5, no more than about 1.4, no more than about 1.3, no more than about 1.2, or no more than about 1.1. Combinations of the above-referenced ratios are also possible (e.g., at least about 1.1 and no more than about 5.0 or at least about 2.0 and no more than about 3.5), inclusive of all ranges and values therebetween. In some embodiments, the ratio between the desired speed and the intake speed is about 1.1, about 1.2, about 1.3, about 1.4, about 1.5, about 1.6, about 1.7, about 1.8, about 1.9, about 2.0, about 2.5, about 3.0, about 4.0, or about 5.0.

The second portion 206 tapers away from the first portion 206. As fluid exits the outlets 208, a second portion 206 without tapering would result in a pressure drop within the plenum 202 that would decrease the speed of the fluid. The taper of the second portion 206 is configured to maintain the desired speed of the fluid exiting each of the outlets 208. In some embodiments, the height of the second portion 206 tapers. In some embodiments, the width of the second portion 206 tapers. In some embodiments, both the height and the width of the second portion 206 taper.

FIG. 2B is an illustration of a side view of the plenum 202 of FIG. 2A. The first portion 204 of the plenum 202 defines a first length 204a, a first height 204b, a first taper distance 204c, and an intake port 205. The first length 204a is the length of the first portion 204 from the intake port 205 to the second portion 206. The first height 204b is the vertical height of the plenum 202 at the intake port 205.

In some embodiments, the first height 204b is at least about 10 mm, at least about 20 mm, at least about 30 mm, at least about 40 mm, at least about 50 mm, at least about 75 mm, at least about 100 mm, at least about 125 mm, at least about 150 mm, at least about 175 mm, at least about 200 mm. In some embodiments, the first height 204b is no more than about 300 mm, no more than about 175 mm, no more than about 150 mm, no more than about 125 mm, no more than about 100 mm, no more than about 75 mm, no more than about 50 mm, no more than about 40 mm, no more than about 30 mm, no more than about 20 mm, or no more than about 10 mm. Combinations of the above-referenced lengths are also possible (e.g., at least about 10 mm and no more than about 200 mm or at least about 50 mm and no more than 140 mm), inclusive of all ranges and values therebetween. In some embodiments, the first height 204b is about 10 mm, about 20 mm, about 30 mm, about 40 mm, about 50 mm, about 75 mm, about 100 mm, about 125 mm, about 150 mm, about 175 mm, or about 300 mm.

The first portion 204 tapers from the first height 204b to the second portion 206 by a first taper distance 204c. The length of the first taper distance 204c is constrained such that the first taper distance 204c cannot be greater than the first height 204b. In some embodiments, the desired first taper distance 204c is determined based on the relationship between the intake speed and the desired speed of the fluid. In some embodiments, the length of the first taper distance 204c may be related to the first length 204a and/or the first height 204b.

In some embodiments, the first taper distance 204c is at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 100%, at least about 110%, at least about 120%, at least about 130%, at least about 140%, or at least about 150% of the first length 204a. In some embodiments, the first taper distance 204c is no more than 150%, no more than about 140%, no more than about 130%, no more than about 120%, no more than about 110%, no more than about 100%, no more than about 90%, no more than about 80%, no more than about 70%, no more than about 60%, no more than about 50%, no more than about 40%, no more than about 30%, no more than about 25%, no more than about 20%, no more than about 15%, no more than about 10%, no more than about 9%, no more than about 8%, no more than about 7%, no more than about 6%, no more than about 5%, no more than about 4%, no more than about 3%, no more than about 2%, or no more than about 1% of the first length 204a. Combinations of the above-referenced relationships between the first taper distance 204c and the first length 204a are also possible (e.g., at least about 1% of the first length 204a and no more than 150% of the first length 204a or up to 20% of the first length 204a and no more than 90% of the first length 204a), inclusive of all ranges and values therebetween. In some embodiments, the first taper distance 204c is about 1%, about 2%, about 3%, about 4%, about 5%, about 6%, about 7%, about 8%, about 9%, about 10%, about 15%, about 20%, about 25%, about 30%, about 40%, about 50%, about 60%, about 70%, about 80%, about 90%, about 100%, about 110%, about 120%, about 130%, about 140%, or about 150% of the first length 204a.

In some the embodiments, the first taper distance 204c is directly related to the first length 204a. In some embodiments, the first taper distance 204c is at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 99% of the first height 204b. In some embodiments, the first taper distance 204c is no more than 99%, no more than about 90%, no more than about 80%, no more than about 70%, no more than about 60%, no more than about 50%, no more than about 40%, no more than about 30%, no more than about 25%, no more than about 20%, no more than about 15%, no more than about 10%, no more than about 9%, no more than about 8%, no more than about 7%, no more than about 6%, no more than about 5%, no more than about 4%, no more than about 3%, no more than about 2%, or no more than about 1% of the first height 204b. Combinations of the above-referenced relationships between the first taper distance 204c and the first height 204b are also possible (e.g., at least about 1% of the first height 204b and no more than 99% of the first height 204b or up to 20% of the first length 204b and no more than 90% of the first length 204b), inclusive of all ranges and values therebetween. In some embodiments, the first taper distance 204c is about 1%, about 2%, about 3%, about 4%, about 5%, about 6%, about 7%, about 8%, about 9%, about 10%, about 15%, about 20%, about 25%, about 30%, about 40%, about 50%, about 60%, about 70%, about 80%, about 90%, about 100%, about 110%, about 120%, about 130%, about 140%, or about 150% of the first height 204b.

The taper of the first portion 204 forms a first taper angle A1. In some embodiments, the first taper angle A1 is at least about 1 degree, at least about 2 degrees, at least about 3 degrees, at least about 4 degrees, at least about 5 degrees, at least about 6 degrees, at least about 7 degrees, at least about 8 degrees, at least about 9 degrees, at least about 10 degrees, at least about 15 degrees, at least about 20 degrees, at least about 25 degrees, at least about 30 degrees, at least about 40 degrees, at least about 50 degrees, at least about 60 degrees, at least about 70 degrees, or at least about 75 degrees. In some embodiments, the first taper angle A1 is no more than about 75 degrees, no more than about 70 degrees, no more than about 60 degrees, no more than about 50 degrees, no more than about 40 degrees, no more than about 30 degrees, no more than about 25 degrees, no more than about 20 degrees, no more than about 15 degrees, no more than about 10 degrees, no more than about 9 degrees, no more than about 8 degrees, no more than about 7 degrees, no more than about 6 degrees, no more than about 5 degrees, no more than about 4 degrees, no more than about 3 degrees, no more than about 2 degrees, or no more than about 1 degree. Combinations of the above-referenced angles are also possible (e.g., at least about 1 degree and no more than 75 degrees or at least about 10 degrees and no more than 50 degrees), inclusive of all ranges and values therebetween. In some embodiments, the first taper angle is about 1 degree, about 2 degrees, about 3 degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 40 degrees, about 50 degrees, about 60 degrees, about 70 degrees, about 75 degrees.

The second portion 206 of the plenum 202 defines a second length 206a, a second height 206b, and a second taper distance 206c. The second length 206a is the horizontal distance of the second portion 206 from the first portion 204 to the end of the plenum 202. The second height 206b is the height of the plenum 202 at end of the first portion 204 and the beginning of the second portion 206. The second height 206b corresponds to the difference between the first height 204b and the first taper distance 204c.

In some embodiments, the second height 206b is at least about 10 mm, at least about 20 mm, at least about 30 mm, at least about 40 mm, at least about 50 mm, at least about 75 mm, at least about 100 mm, at least about 125 mm, at least about 150 mm, at least about 175 mm, at least about 200 mm. In some embodiments, the second height 206b is no more than about 200 mm, no more than about 175 mm, no more than about 150 mm, no more than about 125 mm, no more than about 100 mm, no more than about 75 mm, no more than about 50 mm, no more than about 40 mm, no more than about 30 mm, no more than about 20 mm, or no more than about 10 mm. Combinations of the above-referenced lengths are also possible (e.g., at least about 10 mm and no more than about 200 mm or at least about 50 mm and no more than 140 mm), inclusive of all ranges and values therebetween. In some embodiments, the second height 204b is about 10 mm, about 20 mm, about 30 mm, about 40 mm, about 50 mm, about 75 mm, about 100 mm, about 125 mm, about 150 mm, about 175 mm, or about 200 mm. In some embodiments, the second height 206b is constrained such that the second height 206b is not greater than the first height 202b.

The second portion 206 tapers from the second height 206b to the end of the second portion 206 along the z-axis by a second taper distance 206c. The length of the second taper distance 206c is constrained such that the second taper distance 206c cannot be greater than the second height 206b. In some embodiments, the desired second taper distance 206c is determined such that the speed of the fluid exiting the outlets 208 is approximately equal. In some embodiments, the length of the second taper distance 206c may be related to the second length 206a and/or the second height 204b.

In some embodiments, the second taper distance 206c is at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 100%, at least about 110%, at least about 120%, at least about 130%, at least about 140%, or at least about 150% of the second length 206a. In some embodiments, the second taper distance 206c is no more than 150%, no more than about 140%, no more than about 130%, no more than about 120%, no more than about 110%, no more than about 100%, no more than about 90%, no more than about 80%, no more than about 70%, no more than about 60%, no more than about 50%, no more than about 40%, no more than about 30%, no more than about 25%, no more than about 20%, no more than about 15%, no more than about 10%, no more than about 9%, no more than about 8%, no more than about 7%, no more than about 6%, no more than about 5%, no more than about 4%, no more than about 3%, no more than about 2%, or no more than about 1% of the second length 206a. Combinations of the above-referenced relationships between the second taper distance 204c and the second length 204a are also possible (e.g., at least about 1% of the second length 206a and no more than 150% of the second length 206a or up to 20% of the second length 206a and no more than 90% of the second length 206a), inclusive of all ranges and values therebetween. In some embodiments, the second taper distance 206c is about 1%, about 2%, about 3%, about 4%, about 5%, about 6%, about 7%, about 8%, about 9%, about 10%, about 15%, about 20%, about 25%, about 30%, about 40%, about 50%, about 60%, about 70%, about 80%, about 90%, about 100%, about 110%, about 120%, about 130%, about 140%, or about 150% of the second length 206a.

In some the embodiments, the second taper distance 206c is directly related to the second length 206a. In some embodiments, the second taper distance 206c is at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 99% of the second height 206b. In some embodiments, the second taper distance 206c is no more than 99%, no more than about 90%, no more than about 80%, no more than about 70%, no more than about 60%, no more than about 50%, no more than about 40%, no more than about 30%, no more than about 25%, no more than about 20%, no more than about 15%, no more than about 10%, no more than about 9%, no more than about 8%, no more than about 7%, no more than about 6%, no more than about 5%, no more than about 4%, no more than about 3%, no more than about 2%, or no more than about 1% of the second height 206b. Combinations of the above-referenced relationships between the second taper distance 206c and the second height 206b are also possible (e.g., at least about 1% of the second height 206b and no more than 99% of the second height 206b or up to 20% of the second length 206b and no more than 90% of the second length 206b), inclusive of all ranges and values therebetween. In some embodiments, the second taper distance 206c is about 1%, about 2%, about 3%, about 4%, about 5%, about 6%, about 7%, about 8%, about 9%, about 10%, about 15%, about 20%, about 25%, about 30%, about 40%, about 50%, about 60%, about 70%, about 80%, about 90%, about 100%, about 110%, about 120%, about 130%, about 140%, or about 150% of the second height 206b.

The taper of the second portion 206 forms a second taper angle A2. In some embodiments, the second taper angle A2 is at least about 1 degree, at least about 2 degrees, at least about 3 degrees, at least about 4 degrees, at least about 5 degrees, at least about 6 degrees, at least about 7 degrees, at least about 8 degrees, at least about 9 degrees, at least about 10 degrees, at least about 15 degrees, at least about 20 degrees, at least about 25 degrees, at least about 30 degrees, at least about 40 degrees, at least about 50 degrees, at least about 60 degrees, at least about 70 degrees, or at least about 75 degrees. In some embodiments, the second taper angle A2 is no more than about 75 degrees, no more than about 70 degrees, no more than about 60 degrees, no more than about 50 degrees, no more than about 40 degrees, no more than about 30 degrees, no more than about 25 degrees, no more than about 20 degrees, no more than about 15 degrees, no more than about 10 degrees, no more than about 9 degrees, no more than about 8 degrees, no more than about 7 degrees, no more than about 6 degrees, no more than about 5 degrees, no more than about 4 degrees, no more than about 3 degrees, no more than about 2 degrees, or no more than about 1 degree. Combinations of the above-referenced angles are also possible (e.g., at least about 1 degree and no more than 75 degrees or at least about 10 degrees and no more than 50 degrees), inclusive of all ranges and values therebetween. In some embodiments, the second taper angle A2 is about 1 degree, about 2 degrees, about 3 degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 40 degrees, about 50 degrees, about 60 degrees, about 70 degrees, about 75 degrees. In some embodiments, the second taper angle A2 is smaller than the first taper angle A1.

FIG. 2C is an illustration of a top view of the plenum 202 of FIG. 2A. FIG. 2C illustrates the first width 204e of the first portion 204 and the second width 206e of the second portion 206. The first portion 204 tapers from the first width 204e to the second width 206e. The difference between the first width 204e and the second width 206e is two times the width taper distance 204f. In other words, the first width 204e is equal to the second width 206e plus two times the width taper distance 204f, as the first portion 204 is tapered by the width taper distance 204f along the y-axis on either side of the first portion 204.

In some embodiments, the desired width taper distance 204f is determined based on the relationship between the intake speed and the desired speed of the fluid. In some embodiments, the length of the width taper distance 204f may be related to the first length 204a and/or the first width 204e.

In some embodiments, the width taper distance 204f is at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 100%, at least about 110%, at least about 120%, at least about 130%, at least about 140%, or at least about 150% of the first length 204a. In some embodiments, the width taper distance 204f is no more than 150%, no more than about 140%, no more than about 130%, no more than about 120%, no more than about 110%, no more than about 100%, no more than about 90%, no more than about 80%, no more than about 70%, no more than about 60%, no more than about 50%, no more than about 40%, no more than about 30%, no more than about 25%, no more than about 20%, no more than about 15%, no more than about 10%, no more than about 9%, no more than about 8%, no more than about 7%, no more than about 6%, no more than about 5%, no more than about 4%, no more than about 3%, no more than about 2%, or no more than about 1% of the first length 204a. Combinations of the above-referenced relationships between the width taper distance 204f and the first length 204a are also possible (e.g., at least about 1% of the first length 204a and no more than 150% of the first length 204a or up to 20% of the first length 204a and no more than 90% of the first length 204a), inclusive of all ranges and values therebetween. In some embodiments, the width taper distance 204f is about 1%, about 2%, about 3%, about 4%, about 5%, about 6%, about 7%, about 8%, about 9%, about 10%, about 15%, about 20%, about 25%, about 30%, about 40%, about 50%, about 60%, about 70%, about 80%, about 90%, about 100%, about 110%, about 120%, about 130%, about 140%, or about 150% of the first length 204a.

In some the embodiments, the width taper distance 204f is directly related to the first width 204e. In some embodiments, the width taper distance 204f is at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 70%, at least about 80%, at least about 90%, at least about 99% of the first width 204e. In some embodiments, the width taper distance 204f is no more than 99%, no more than about 90%, no more than about 80%, no more than about 70%, no more than about 60%, no more than about 50%, no more than about 40%, no more than about 30%, no more than about 25%, no more than about 20%, no more than about 15%, no more than about 10%, no more than about 9%, no more than about 8%, no more than about 7%, no more than about 6%, no more than about 5%, no more than about 4%, no more than about 3%, no more than about 2%, or no more than about 1% of the first width 204e. Combinations of the above-referenced relationships between the width taper distance 204f and the first width 204e are also possible (e.g., at least about 1% of the first width 204e and no more than 99% of the first width 204e or up to 20% of the first width 204e and no more than 90% of the first width 204e), inclusive of all ranges and values therebetween. In some embodiments, the width taper distance 204f is about 1%, about 2%, about 3%, about 4%, about 5%, about 6%, about 7%, about 8%, about 9%, about 10%, about 15%, about 20%, about 25%, about 30%, about 40%, about 50%, about 60%, about 70%, about 80%, about 90%, about 100%, about 110%, about 120%, about 130%, about 140%, or about 150% of the first width 204e.

The taper of the first portion 204 forms a third taper angle A3. In some embodiments, the third taper angle A3 is at least about 1 degree, at least about 2 degrees, at least about 3 degrees, at least about 4 degrees, at least about 5 degrees, at least about 6 degrees, at least about 7 degrees, at least about 8 degrees, at least about 9 degrees, at least about 10 degrees, at least about 15 degrees, at least about 20 degrees, at least about 25 degrees, at least about 30 degrees, at least about 40 degrees, at least about 50 degrees, at least about 60 degrees, at least about 70 degrees, or at least about 75 degrees. In some embodiments, the third taper angle A3 is no more than about 75 degrees, no more than about 70 degrees, no more than about 60 degrees, no more than about 50 degrees, no more than about 40 degrees, no more than about 30 degrees, no more than about 25 degrees, no more than about 20 degrees, no more than about 15 degrees, no more than about 10 degrees, no more than about 9 degrees, no more than about 8 degrees, no more than about 7 degrees, no more than about 6 degrees, no more than about 5 degrees, no more than about 4 degrees, no more than about 3 degrees, no more than about 2 degrees, or no more than about 1 degree. Combinations of the above-referenced angles are also possible (e.g., at least about 1 degree and no more than 75 degrees or at least about 10 degrees and no more than 50 degrees), inclusive of all ranges and values therebetween. In some embodiments, the third taper angle A3 is about 1 degree, about 2 degrees, about 3 degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 40 degrees, about 50 degrees, about 60 degrees, about 70 degrees, about 75 degrees.

FIG. 2C also illustrates the starting distance 208a, the interval distance 208b, and the length 208c of the outlets 208. The starting distance 208a is the distance from the end of the first portion 204 to the first outlet 208. In some embodiments, the starting distance 208a is determined so that the fluid exiting the outlet 208 nearest to the first portion exits at the desired speed. In some embodiments, the starting distance 208a is at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 15 mm, at least about 20 mm, at least about 25 mm, at least about 30 mm, at least about 40 mm, at least about 50 mm, at least about 60 mm, at least about 70 mm, at least about 80 mm, at least about 90 mm, at least about 100 mm, at least about 110 mm, at least about 120 mm, at least about 130 mm, at least about 140 mm, or at least about 150 mm. In some embodiments, the starting distance 208a is no more than about 150 mm, no more than about 140 mm, no more than about 130 mm, no more than about 120 mm, no more than about 110 mm, no more than about 100 mm, no more than about 90 mm, no more than about 80 mm, no more than about 70 mm, no more than about 60 mm, no more than about 50 mm, no more than about 40 mm, no more than about 40 mm, no more than about 30 mm, no more than about 25 mm, no more than about 20 mm, no more than about 20 mm, no more than about 15 mm, no more than about 10 mm, no more than about 9 mm, no more than about 8 mm, no more than about 7 mm, no more than about 6 mm, no more than about 5 mm, no more than about 4 mm, no more than about 3 mm, no more than about 2 mm, or no more than about 1 mm. Combinations of the above-referenced starting distances 208a are also possible (e.g., at least about 1 mm and no more than about 150 mm or at least about 5 mm and no more than about 100 mm), inclusive of all ranges and values therebetween. In some embodiments, the starting distance 208a is about 1 mm, about 2 mm, about 3 mm, about 4 mm, about 5 mm, about 6 mm, about 7 mm, about 8 mm, about 9 mm, about 10 mm, about 15 mm, about 20 mm, about 25 mm, about 30 mm, about 40 mm, about 50 mm, about 60 mm, about 70 mm, about 80 mm, about 90 mm, about 100 mm, about 110 mm, about 120 mm, about 130 mm, about 140 mm, or about 150 mm.

The interval distance 208b is the distance between the outlets 208. The interval distance 208b may be equal between all of the outlets 208. In some embodiments, the interval distance 208b corresponds to the width of a battery module so that the battery module may be situated between the outlets 208. In some embodiments, the interval distance 208b is at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 15 mm, at least about 20 mm, at least about 25 mm, at least about 30 mm, at least about 40 mm, at least about 50 mm, at least about 60 mm, at least about 70 mm, at least about 80 mm, at least about 90 mm, at least about 100 mm, at least about 110 mm, at least about 120 mm, at least about 130 mm, at least about 140 mm, or at least about 500 mm. In some embodiments, the interval distance 208b is no more than about 500 mm, no more than about 140 mm, no more than about 130 mm, no more than about 120 mm, no more than about 110 mm, no more than about 100 mm, no more than about 90 mm, no more than about 80 mm, no more than about 70 mm, no more than about 60 mm, no more than about 50 mm, no more than about 40 mm, no more than about 40 mm, no more than about 30 mm, no more than about 25 mm, no more than about 20 mm, no more than about 20 mm, no more than about 15 mm, no more than about 10 mm, no more than about 9 mm, no more than about 8 mm, no more than about 7 mm, no more than about 6 mm, no more than about 5 mm, no more than about 4 mm, no more than about 3 mm, no more than about 2 mm, or no more than about 1 mm. Combinations of the above-referenced interval distance 208b are also possible (e.g., at least about 1 mm and no more than about 500 mm or at least about 5 mm and no more than about 100 mm), inclusive of all ranges and values therebetween. In some embodiments, the interval distance 208b is about 1 mm, about 2 mm, about 3 mm, about 4 mm, about 5 mm, about 6 mm, about 7 mm, about 8 mm, about 9 mm, about 10 mm, about 15 mm, about 20 mm, about 25 mm, about 30 mm, about 40 mm, about 50 mm, about 60 mm, about 70 mm, about 80 mm, about 90 mm, about 100 mm, about 110 mm, about 120 mm, about 130 mm, about 140 mm, or about 500 mm.

The length 208c corresponds to the length of the outlets 208c along the y-axis. The length 208c corresponds to a dimension of a heat exchanger (e.g., functionally and/or structurally similar to the heat exchanger 110 of FIG. 1). In some embodiments, the length 208c of all of the outlets 208 is about equal. In some embodiments, the length 208c is at least about 50 mm, at least about 60 mm, at least about 70 mm, at least about 80 mm, at least about 90 mm, at least about 100 mm, at least about 110 mm, at least about 120 mm, at least about 130 mm, at least about 140 mm, at least about 150 mm, at least about 160 mm, at least about 170 mm, at least about 180 mm, at least about 190 mm, at least about 200 mm, at least about 210 mm, at least about 220 mm, at least about 230 mm, at least about 240 mm, or at least about 2500 mm. In some embodiments, the length 208c is no more than about 2500 mm, no more than about 240 mm, no more than about 230 mm, no more than about 220 mm, no more than about 210 mm, no more than about 200 mm, no more than about 190 mm, no more than about 180 mm, no more than about 170 mm, no more than about 160 mm, no more than about 150 mm, no more than about 140 mm, no more than about 130 mm, no more than about 120 mm, no more than about 110 mm, no more than about 100 mm, no more than about 90 mm, no more than about 80 mm, no more than about 70 mm, no more than about 60 mm, or no more than about 50 mm. Combinations of the above-reference lengths 208b are also possible (e.g., at least about 50 mm and no more than about 250 mm or at least about 100 mm and not more than about 200 mm), inclusive of all ranges and values therebetween. In some embodiments, the length 208c can be about 50 mm, about 60 mm, about 70 mm, about 80 mm, about 90 mm, about 100 mm, about 110 mm, about 120 mm, about 130 mm, about 140 mm, about 150 mm, about 160 mm, about 170 mm, about 180 mm, about 190 mm, about 200 mm, about 210 mm, about 220 mm, about 230 mm, about 240 mm, or about 2500 mm.

The outlets 208 also have an outlet width (i.e., a width along the x-axis). The outlet width corresponds to a dimension of the heat exchanger. In some embodiments, the outlet width of all of the outlets 208 is approximately equal. In some embodiments, the outlet width is at least about 0.1 mm, at least about 0.2 mm, at least about 0.3 mm, at least about 0.4 mm, at least about 0.5 mm, at least about 0.6 mm, at least about 0.7 mm, at least about 0.8 mm, at least about 0.9 mm, at least about 1.0 mm, at least about 1.5 mm, at least about 2.0 mm, at least about 2.5 mm, at least about 3.0 mm, at least about 4.0 mm, at least about 5.0, at least about 6.0 mm, at least about 7.0 mm, at least about 8.0 mm, at least about 9.0 mm, at least about 10 mm, at least about 15 mm, or at least about 20 mm. In some embodiments, the outlet width is no more than about 20 mm, no more than about 15 mm, no more than about 10 mm, no more than about 9.0 mm, no more than about 8.0 mm, no more than about 7.0 mm, no more than about 6.0 mm, no more than about 5.0 mm, no more than about 4.0, no more than about 3.0, no more than about 2.5 mm, no more than about 2.0 mm, no more than about 1.5 mm, no more than about 1.0 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2, or no more than about 0.1 mm. Combinations of the above-referenced outlets widths are also possible (e.g., at least about 0.1 mm and no more than about 20 mm or at least about 2 mm and no more than about 6 mm), inclusive of all ranges and values therebetween. In some embodiments, the outlet width is about 0.1 mm, about 0.2 mm, about 0.3 mm, about 0.4 mm, about 0.5 mm, about 0.6 mm, about 0.7 mm, about 0.8 mm, about 0.9 mm, about 1.0 mm, about 1.5 mm, about 2.0 mm, about 2.5 mm, about 3.0 mm, about 4.0 mm, about 5.0 mm, about 6.0 mm, about 7.0 mm, about 8.0 mm, about 9.0 mm, about 10 mm, about 15 mm, or about 20 mm.

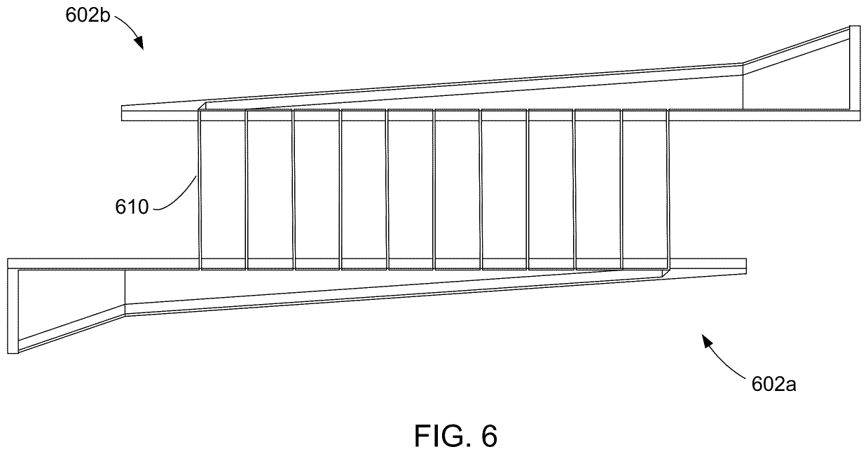

FIG. 2D is a perspective view of the plenum 202 of FIG. 2A coupled to a set of heat exchangers 210. As shown, the heat exchangers 210 are inserted into a subset of the outlets 208. The outlets 208 alternate between filled and unfilled. In some embodiments, the heat exchangers 210 can be inserted into all of the outlets 208. In some embodiments, outlets 208 that do not have a heat exchanger 210 may be sealed, plugged, covered, or otherwise blocked. Fluid travels through the plenum 202 from the first portion 204 to the second portion 206 and out of the outlets 208 into a heat exchanger inlet 210a. The fluid travels through the heat exchanger 210 from the heat exchanger inlet 210a to a heat exchanger outlet 210b. In some embodiments, the heat exchanger outlet 210b maybe be fluidly coupled to an exhaust system, a fluid recycling system, or the like. In some embodiments, the heat exchanger outlet 210b may be fluidly coupled to another plenum 202 that is configured to receive the exhausted fluid (e.g., shown in FIG. 6).

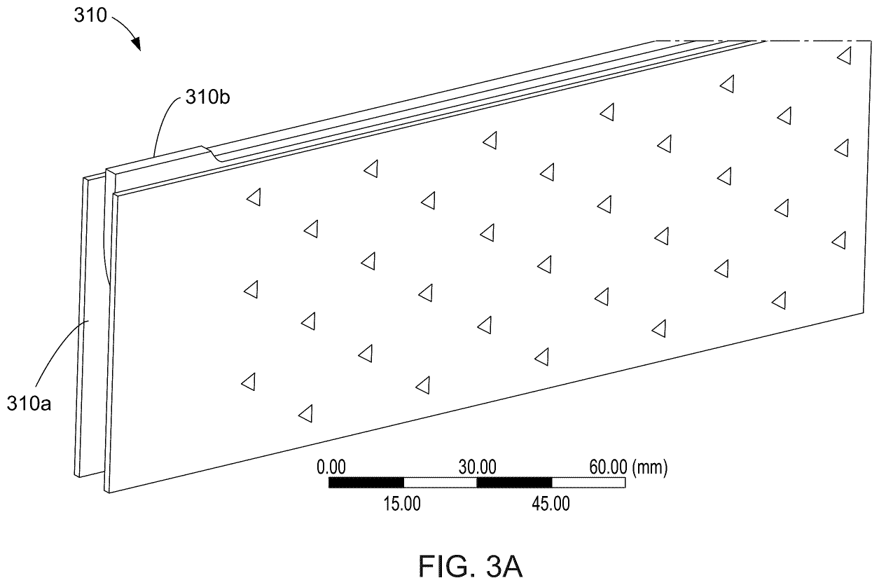

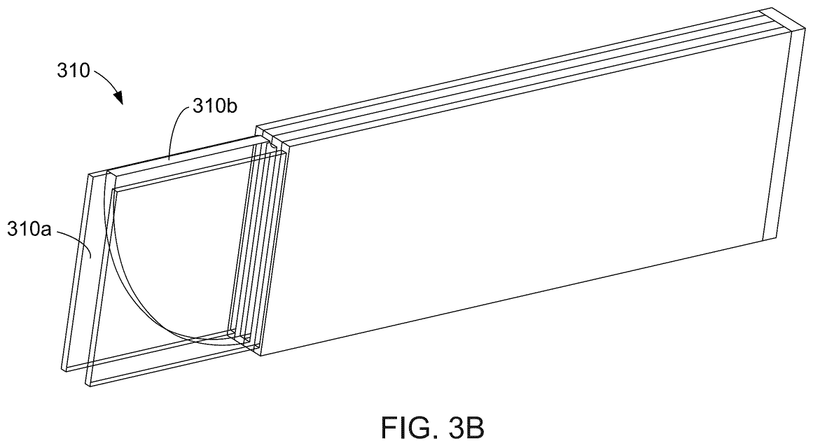

FIGS. 3A-3B depict illustrations of an alternate heat exchanger 310 (e.g., functionally similar to the heat exchanger 110 of FIG. 1 and the heat exchanger 210 of FIG. 2D), according to an embodiment. The heat exchanger 310 also receives fluid via a heat exchanger inlet 310a (e.g., functionally similar to the heat exchanger inlet 210a of FIG. 2D), but instead of exhausting fluid out of the opposite end of the heat exchanger 310, as in the heat exchanger 210 of FIG. 2C, the heat exchanger 310 directs the fluid through and around the heat exchanger 310, exhausting the fluid through the heat exchanger outlet 310b located 90 degrees away from the heat exchanger inlet 310a. As seen in FIG. 3B, the fluid travels through outside passages in the heat exchanger 310 before converging and returning to a central passage which ducts to the heat exchanger outlet 310b. The alternate heat exchanger 310 may be utilized in applications where vertical clearance is limited. Other configurations of heat exchanger are also possible depending on the application of the heat exchanger 310.

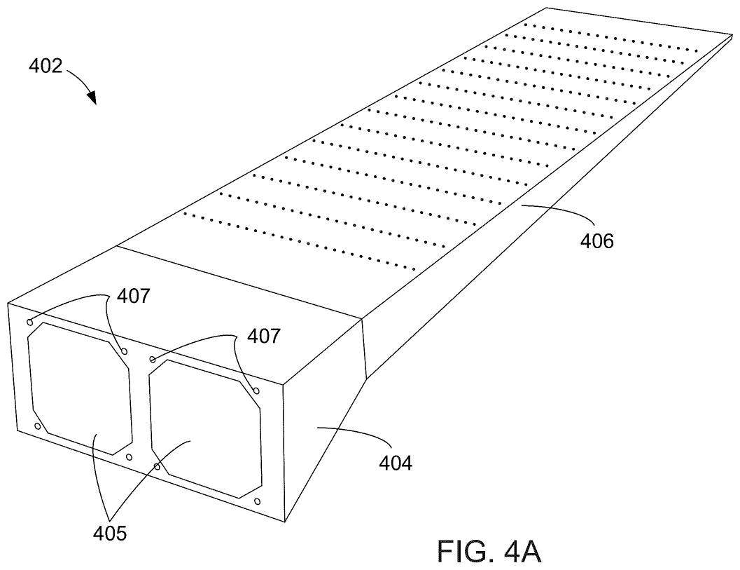

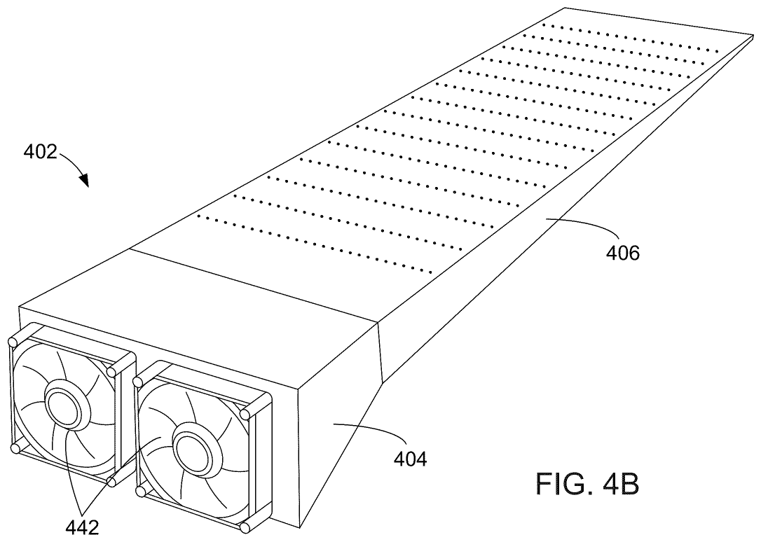

FIGS. 4A-4B are illustrations of a plenum 402, according to an embodiment. FIG. 4A is an illustration of a perspective view of the plenum 402 (e.g., functionally and/or structurally similar to the plenum 102 of FIG. 1), according to an embodiment. The plenum 402 includes a first portion 404 (e.g., functionally and/or structurally similar to the first portion 204 of FIGS. 2A-2D), two intake ports 405 (e.g., functionally and/or structurally similar to the intake port 205 of FIGS. 2A-2D), and a second portion 406 (e.g., functionally and/or structurally similar to the second portion 206 if FIGS. 2A-2D). The plenum 402 includes two intake ports 405 to provide system redundancy in case of a failure. The intake ports 405 are configured to receive a component of the fluid system such as a fan, a conduit, or the like via a set of mounting points 407. In some embodiments, the mounting point 407 may be threaded to receive a screw. In some embodiments, the mounting point 407 may include at least a portion of a fastener (e.g., clip, buckle, nut, pin, etc.). The intake port 405 is sized to correspond to the size of the component of the fluid system. For example, if an 80 mm fan is mounted over the intake port 405, then the intake port may be approximately 80 mm wide. In some embodiments, the width of each intake port 405 is at least about 10 mm, at least about 20 mm, at least about 30 mm, at least about 40 mm, at least about 50 mm, at least about 60 mm, at least about 70 mm, at least about 80 mm, at least about 90 mm, at least about 100 mm, at least about 110 mm, at least about 120 mm, at least about 130 mm, at least about 140 mm, at least about 150 mm, at least about 160 mm, at least about 170 mm, at least about 180 mm, at least about 190 mm, or at least about 200 mm. In some embodiments, the width of each intake port 405 is no more than about 400 mm, no more than about 190 mm, no more than about 180 mm, no more than about 170 mm, no more than about 160 mm, no more than about 150 mm, no more than about 140 mm, no more than about 130 mm, no more than about 120 mm, no more than about 110 mm, no more than about 100 mm, no more than about 90 mm, no more than about 80 mm, no more than about 70 mm, no more than about 60 mm, no more than about 50 mm, no more than about 40 mm, no more than about 30 mm, no more than about 20 mm, or no more than about 10 mm. Combinations of the above-referenced widths are also possible (e.g., at least about 10 mm and no more than about 200 mm or at least about 50 mm and no more than about 140 mm), inclusive of all ranges and values therebetween. In some embodiments, the width of each intake port 405 is about 10 mm, about 20 mm, about 30 mm, about 40 mm, about 50 mm, about 60 mm, about 70 mm, about 80 mm, about 90 mm, about 100 mm, about 110 mm, about 120 mm, about 130 mm, about 140 mm, about 150 mm, about 160 mm, about 170 mm, about 180 mm, about 190 mm, or about 400 mm.

FIG. 4B is an illustration of the plenum 402 of FIG. 4A coupled to fans 442. The fans 442 are mounted to the mounting points 407. The fans 442 draw fluid either into or out of the plenum 402. Two fans 442 are included to provide redundancy in case one fails. In some embodiments, both fans 442 are utilized to reach the desired speed of the fluid. In some embodiments, one fan 442 may be capable of accelerating fluid to the desired speed. In some embodiments, the fans 442 may be 80 mm fans. In some embodiments, the fans 442 may be fluidly coupled to a fluid reservoir or conduit to receive and/or direct fluid to another location. In some embodiments, the fans 442 are coupled to a battery management system (BMS) that controls the speed of the fans to control the temperatures within the battery system (e.g., the battery system 100 of FIG. 1).

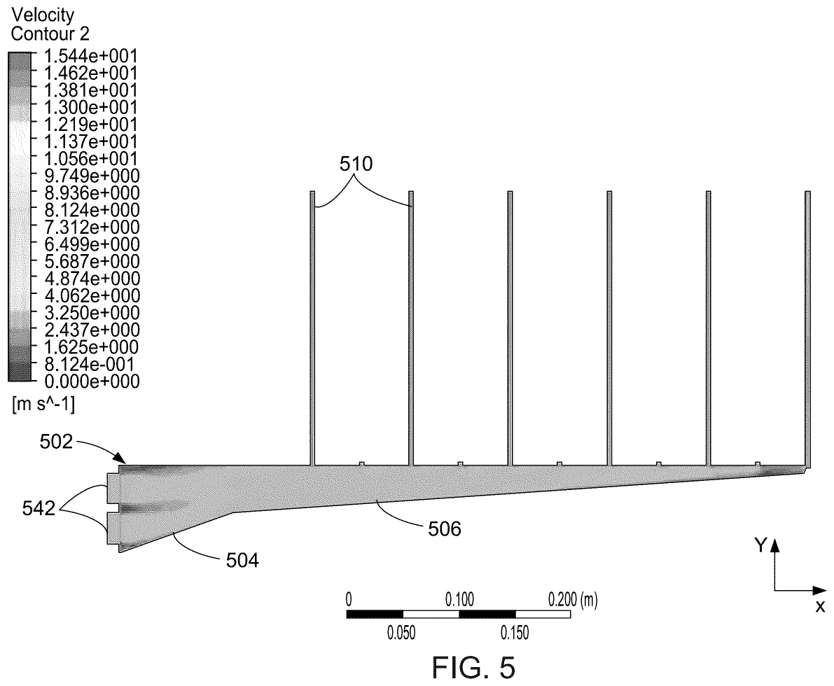

FIG. 5 is an illustration of fluid flow through a plenum 502 (e.g., functionally and/or structurally similar to the plenum 102 of FIG. 1) and heat exchangers 510 (e.g., functionally and/or structurally similar to the heat exchangers 110 of FIG. 1), according to an embodiment. Fans 542 (e.g., structurally and/or functionally similar to the fans 442 of FIG. 4B), coupled to a first portion 504 (e.g., functionally and/or structurally similar to the first portion 104 of FIG. 1) of the plenum 502, direct fluid through first portion 504 to a second portion 506 (e.g., structurally and/or functionally similar to the second portion 106 of FIG. 1). The fluid is pumped out of outlets 508 (e.g., functionally and/or structurally similar to the outlets 108 of FIG. 1) within the second portion 506 and through the heat exchangers 510. As seen in FIG. 5, the fluid within each of the heat exchangers 510 is roughly equal.

FIG. 6 is an illustration of a side view of a double plenum configuration, according to an embodiment. The double plenum configuration includes an intake plenum 602a and an exhaust plenum 602b (e.g., both are structurally and/or functionally similar to the plenum 102 of FIG. 1). The intake plenum 602a is fluidly coupled to the inlets of a set of heat exchangers 610 (e.g., functionally and/or structurally similar to the heat exchanger 110 of FIG. 1). The outlets of the heat exchangers 610 are coupled to the exhaust plenum 602b. In the double plenum configuration, fluid flows into the intake plenum 602a, through the heat exchangers 610, and into and out of the exhaust plenum 602b. The exhaust plenum 602b captures and exhausts the fluid and may direct the fluid to a reservoir, a fluid conditioning system, or to an exhaust system. The exhaust plenum 602b may be configured to slow down the exhaust flow to a desired speed. In some embodiments, other double plenum configurations are possible when heat exchangers with alternate configurations are used (e.g., the heat exchanger 310 of FIGS. 3A-3B).

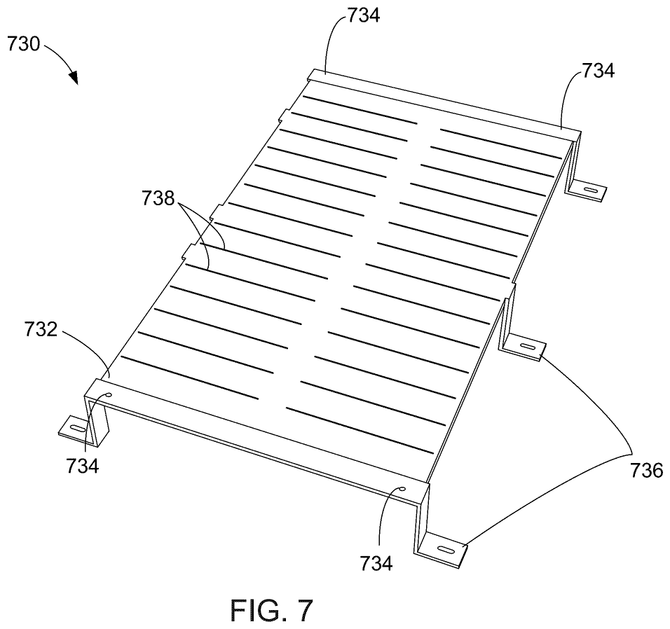

FIG. 7 is an illustration of a base 730 (e.g., structurally and/or functionally similar to the base 130 of FIG. 1) for mounting plenums (e.g., structurally and/or functionally similar to the plenum 102 of FIG. 1), according to an embodiment. The base 730 includes a surface 732, mounting points 734, and support legs 736. The top of the surface 732 is configured to support a battery assembly (e.g., functionally and/or substantially similar to the battery assembly 120 of FIG. 1). The bottom of the surface 732 supports the plenums, which may be mounted to the surface 732 via the mounting point 734. The surface 732 include rows of outlets 738, which correspond in location to the outlets (e.g., functionally and/or structurally similar to the outlets 108 of FIG. 1) of the plenums. The outlets allow for the heat exchangers (e.g., heat exchangers 110 of FIG. 1) to fluidly couple to the plenum. The support legs 736 both raise the surface 732 to allow the plenums to be located under the surface 732 and allow for the base 730 to be mounted to a surface. The height of the support legs 736 is at least as high as the height of the plenums. In some embodiments, the base can be a prismatic box.

The base 730 is configured to support two plenums to be mounted side-by-side. In some embodiments, the base 730 is configured to support at least one plenum, at least two plenums, at least three plenums, at least four plenums, at least five plenums, at least six plenums, at least seven plenums, at least eight plenums, at least nine plenums, or at least 10 plenums. In some embodiments, the base 730 is configured to support no more than 20 plenums, no more than nine plenums, no more than eight plenums, no more than seven plenums, no more than six plenums, no more than five plenums, no more than four plenums, no more than three plenums, no more than two plenums, or no more than one plenum. Combinations of the above-referenced base 730 configurations are also possible (e.g., can support at least one plenum and no more than 10 plenums or can support at least two plenums and no more than four plenums), inclusive of all ranges and values therebetween. In some embodiments, the base 730 is configured to support one plenum, two plenums, three plenums, four plenums, five plenums, six plenums, seven plenums, eight plenums, nine plenums, or 10 plenums.

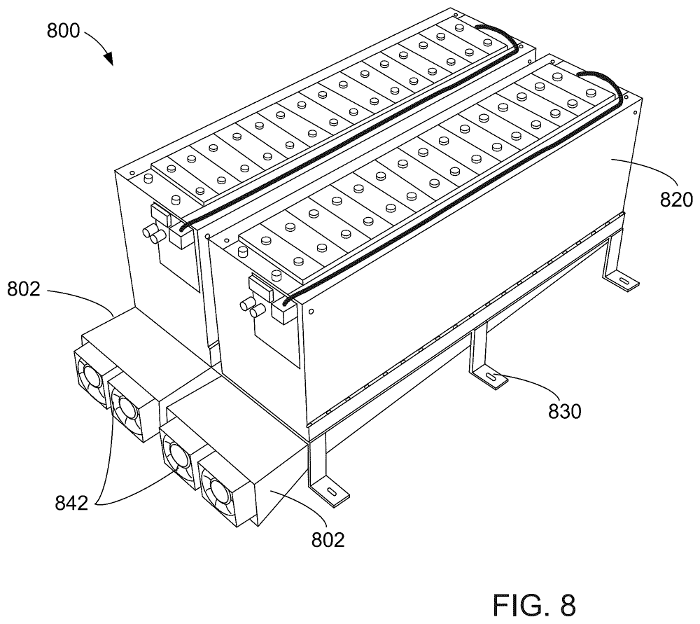

FIG. 8 is an illustration of a battery system 800 (e.g., functionally and/or structurally similar to the battery system 100 of FIG. 1), according to an embodiment. The battery system 800 includes two plenums 802 (e.g., functionally and/or structurally similar to the plenum 102 of FIG. 1), fans 842 (e.g., functionally and/or structurally similar to the fans 142 of FIG. 1), a base 830 (e.g., functionally and/or structurally similar to the base 130 of FIG. 1), and a battery assembly 820 (e.g., functionally and/or structurally similar to the battery system 120 of FIG. 1). The plenums 802 are mounted under the base 830. The battery assembly 802 is mounted on top of the base 830. A set of heat exchangers are located within the battery system 820 between the individual cells. The fans 842 pump fluid into the plenums 802, the which accelerate the fluid to the desired speed and into the heat exchangers. As the fluid passes through the heat exchangers, the fluid absorbs the heat produced by the battery assembly 820.

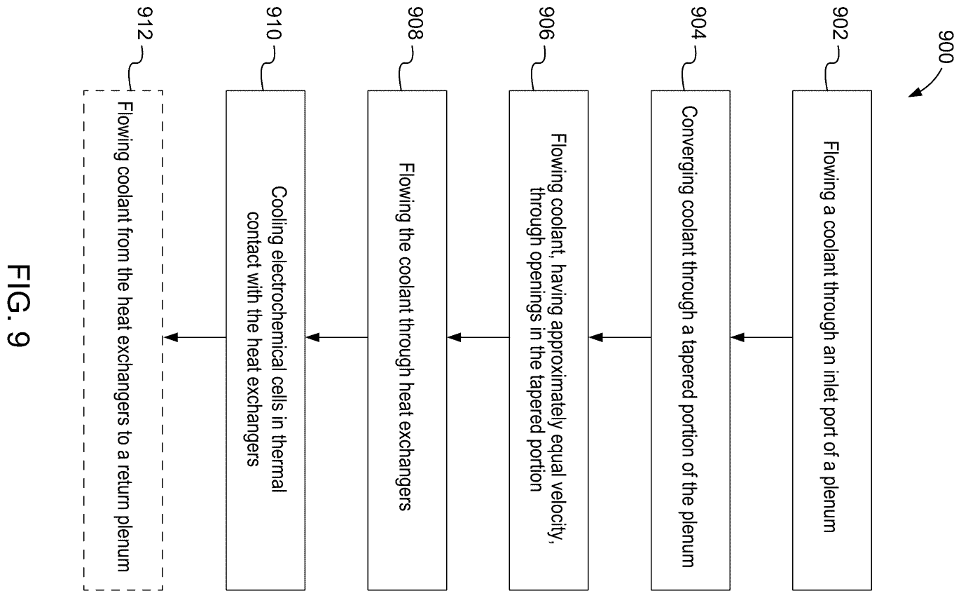

FIG. 9 is a flow diagram of a method 900 of cooling an electrochemical cell system (e.g., functionally and/or substantially similar to the battery assembly 120 of FIG. 1), according to an embodiment. As shown, the method 900 includes flowing a fluid though an inlet port of a plenum at step 902, converging fluid through a tapered portion of the plenum at step 904, flowing fluid, having approximately equal velocity, through outlets in the tapered portion at step 906, flowing the fluid through the heat exchangers at step 908, cooling electrochemical cells in thermal contact with the heat exchangers at step 910, and optionally cooling electrochemical cells in physical contact with the heat exchangers at step 912.

Step 902 includes flowing a fluid through the inlet port (e.g., structurally and/or functionally similar to the intake port 205 of FIG. 2B) of the plenum (e.g., functionally and/or structurally similar to the plenum 102 of FIG. 1). The fluid may be pumped into the inlet port via a component (e.g., functionally and/or structurally similar to the fan 142 of FIG. 1) of a coolant system (e.g., structurally and/or functionally similar to coolant system 140 of FIG. 1). The fluid may be a gas coolant (e.g., air, freon, etc.) or a liquid coolant (e.g., oil, water, etc.). The fluid is flowed into the inlet port at an intake speed.

Step 904 includes converging fluid through a tapered portion of the plenum. The tapered portion accelerates the fluid from the intake speed to a desired speed. In some embodiments, the tapered portion may include multiple portions configured to accelerate flow at different rates. The tapered portion corresponds to a set of outlets (e.g., functionally and/or structurally similar to the outlets 108 of FIG. 1) within the plenum so that the fluid remains at the desired speed even as fluid exits the plenum via the outlets. Thereafter, step 906 includes flowing the fluid, having approximately equal velocity, through outlets in the tapered portion. After flowing through the outlets, step 908 includes flowing fluid through the heat exchangers. The heat exchangers are configured to transfer heat from electrochemical cells into the fluid, which carries the heat away from the electrochemical cells.

Step 910 includes cooling electrochemical cells in thermal contact with the heat exchangers. Cooling the electrochemical cells allows for the electrochemical cells to be maintained at or under a desired operating temperature and prevents thermal runaway. Optional step 912 includes flowing cooling from the heat exchangers to a return plenum. In some embodiments, step 912 includes exhausting the fluid out of the heat exchangers.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A plenum, comprising:
at least one inlet configured to receive a fluid from a coolant system;
a plurality of outlets configured to fluidly couple to a plurality of heat exchangers; and
a tapered portion corresponding to the plurality of outlets, the tapered configured to maintain the fluid at a desired speed.

2. The plenum of claim 1, wherein the tapered portion includes a first section defining a first taper rate and a second section defining a second taper rate.

3. The plenum of claim 2, wherein the second taper rate is lower than the first taper rate.

4. The plenum of claim 1, wherein the inlet includes a first inlet port and a second inlet port.

5. The plenum of claim 4, further comprising:
a first fan coupled to the first inlet port; and
a second fan coupled to the second inlet port.

6. The plenum of claim 1, further comprising:
a base portion proximal to the tapered portion.

7. The plenum of claim 6, wherein the plurality of outlets are positioned on a top surface, the base portion includes a first surface forming a first angle with the top surface and a second surface forming a second angle with the top surface, the second angle less than the first angle.

8. A battery system, comprising:
a battery assembly;
a coolant system;
a plurality of heat exchangers thermally coupled to the battery assembly; and
a plenum comprising:
an inlet configured to receive fluid from the coolant system;
a plurality of outlets configured to fluidly couple to the plurality of heat exchangers; and
a tapered portion corresponding to the plurality of outlets, the tapered configured to maintain the fluid at a desired speed.

9. The battery system of claim 8, wherein the coolant system includes a primary fan and a secondary fan.

10. The battery system of claim 8, further comprising a base, the base configured to support the plenum and the battery assembly.

11. The battery system of claim 8, wherein the coolant system includes a primary pump and a secondary pump.

12. The battery system of claim 8, wherein the plenum is a first plenum, the battery system further including a second plenum coupled to the first plenum via the plurality of heat exchangers.

13. The battery system of claim 12, wherein the plurality of outlets is a first plurality of outlets, the second plenum including a second plurality of outlets, the second plurality of outlets coupled to the first plurality of outlets via the plurality of heat exchangers.

14. The battery system of claim 12, wherein the second plenum includes a tapered portion tapering in an opposite direction to the tapered portion of the tapered portion of the first plenum.

15. A battery system, comprising:
a battery assembly;
a plurality of heat exchangers thermally coupled to the battery system;
a plenum comprising:
a plurality of outlets; and
a tapered portion corresponding to the plurality of outlets, the tapered configured to maintain the fluid at a desired speed, the tapered portion including a first section defining a first taper rate and a second section defining a second taper rate;
a plurality of heat exchangers extending from the plurality of outlets and contacting the plurality of electrochemical cells.

16. The battery system of claim 15, further comprising:
a coolant system configured to deliver a coolant to the plenum.

17. The battery system of claim 16, wherein the coolant system includes a primary fan and a secondary fan.

18. The battery system of claim 15, further comprising a base, the base configured to support the plenum and the battery assembly.

19. The battery system of claim 15, wherein the plenum is a first plenum, the battery system further including a second plenum coupled to the first plenum via the plurality of heat exchangers.

20. The battery system of claim 19, wherein the plurality of outlets is a first plurality of outlets, the second plenum including a second plurality of outlets, the second plurality of outlets coupled to the first plurality of outlets via the plurality of heat exchangers.

21. The battery system of claim 19, wherein the second plenum includes a tapered portion tapering in an opposite direction to the tapered portion of the tapered portion of the first plenum.
